(19) United States
(12) Patent Application Publication
(10) Pub. No.: US 2009/0125340 A1
(43) Pub. Date: May 14, 2009

(54) Booking a Chauffeured Vehicle

(76) Inventor: Peter John Gosney, Black Rock (AU)

Correspondence Address: BIRCH STEWART KOLASCH & BIRCH, PO BOX 747, FALLS CHURCH, VA, 22040-0747, US

(21) Appl. No.: 12/083,090

(22) PCT Filed: Sep. 27, 2006
(86) PCT No.: PCT/AU2006/001416

§ 371 Date: Aug. 1, 2008

Related U.S. Application Data
(60) Provisional application No. 60/723,914, filed on Oct. 6, 2005.

(51) Int. Cl. G06Q 10/00; H04M 3/42; H04W 4/12

(52) U.S. Cl. 705/5; 455/415; 455/466

(57) ABSTRACT

A chauffeured vehicle booking service is provided. A user can use a digital mobile phone that has a “Caller Line Identifier” (hereinafter “CLI”) facility in the mobile service (211) to book a vehicle. The service has a computerised call answering system connected with a plurality of incoming call lines, each having a pre-established unique booking purpose. The system detects the CLI on an incoming call, and assembles a booking message based on the pre-established unique booking purpose associated with the call line on which the user's booking is made. That assembled booking message is then sent back to the user using the extracted CLI. The generation of the message does either or both (a) invites the called to confirm the booking, and if confirmed then places the booking, or

(b) if the caller is an account holder registered in the service, as determined from the extracted CLI, places the booking.

### RELATED APPLICATIONS

This application is based on and claims the benefit of the filing date of U.S. Patent Application Ser. No. 60/723 914 filed Oct. 6, 2005 the contents of which are incorporated herein by reference in its entirety.

### FIELD OF THE INVENTION

This invention relates to booking a chauffeured vehicle and has particular, although not exclusive application for booking a chauffeured vehicle such as a taxi or like chauffeured vehicle at an airport or like pickup location.

### BACKGROUND ART

Hitherto, there have been proposals for automated systems for permitting booking of a chauffeured vehicle at airports or like busy locations. Some prior proposals have utilised a land line telephone service which links directly with a chauffeured vehicle booking organisation. In such instances, airports and like busy locations require permits or authorisation to be given for the installation of this telephone equipment. In some instances, objection has been raised by the airline building managements because providing a permit exclusively to one chauffeured vehicle booking service excludes other possible chauffeured vehicle booking services from participating. An open policy to allow all booking services is not possible. In general, the adoption of prior proposals has been hampered by the approval process required by the airport management. This in turn, means that chauffeured vehicle bookings from airports has not developed to the extent possible.

The present invention proposes an alternative system that does not require installation of similar dedicated and permitted equipment such as dedicated land line phones at the airport. In this context, the system does not require airport management approval for any installation of hardware.

### STATEMENT OF THE INVENTION

Therefore, according to a first aspect of the invention there is provided a chauffeured vehicle booking service where a person can order a chauffeured vehicle using a conventional digital mobile telephone. The service provider of the mobile telephone service provides a caller line identifier (CLI) facility, as is common in current conventional digital mobile telephone technology. A computerised Call answering system is provided that answers a booking Call made by a mobile telephone to anyone of a plurality of incoming Call lines. Each one of the Call lines has a respective pre-established unique booking purpose. The answering system has a CLI detector for extracting the CLI from the booking Call. The answering system then associates the extracted CLI with the incoming Call line to define the caller's intended purpose of the booking Call.

If the caller is identified from the extracted CLI and has an established account with a chauffeured vehicle service, the answering system assembles a booking message and places an order with the chauffeured vehicle service. When the chauffeured vehicle service subsequently responds, the answering system assembles a booking message back to the caller based on the pre-established unique booking purpose for that Call line. The message is despatched to the caller's mobile telephone using the extracted CLI, and an invitation is offered to the caller to confirm receipt.

If the caller is not identified, the answering system assembles a booking message back to the caller based on the pre-established unique booking purpose for that Call line. The message is despatched to the caller's mobile telephone using the extracted CLI, and an invitation is offered to the caller to confirm the booking. The caller then confirms the booking and the booking is then placed with a chauffeured vehicle service.

In one example, the mobile telephone is a short message service (SMS) enabled mobile telephone and the assembled booking message is an SMS message sent to the caller as an SMS message.

In another example, the answering system provides a booking initiation signal following confirmation of the booking. This signal is then passed to a computerised booking vehicle despatched system to place the booking.

The unique CLI of the caller can, but need not identify:
1. Caller's name;
2. Caller's own purpose for the incoming Call line;
3. Caller's account with a participating chauffeured vehicle service;

The pre-established unique booking purpose identifies at least one of, but not limited only to:
1. Caller's pickup location;
2. Caller's destination;
3. Caller's choice of vehicle;
4. Caller's method of settlement of charges;
5. Caller's requirement for progress reports tracking the booking;
6. Caller's intention to place a booking for pick up at a future time;

### BRIEF DESCRIPTION OF DRAWINGS

In order that the invention can be more clearly ascertained examples will now be described with reference to the accompanying drawings wherein:

FIG. 1 shows a credit card sized card that has a Side A and Side B, showing a particular airport on Side A, and particular pickup points on Side B,

FIG. 2 is a high level functional flow diagram showing process steps for the booking of a chauffeured vehicle in the example,

FIG. 3 is a detailed level function flow diagram showing more detail of the process steps shown in FIG. 2.

FIGS. 4a-4c are block schematic diagrams of system components and functional flows between those components in three examples of screen displays.

FIG. 5 is a display of a conventional digital mobile telephone screen showing an example of a booking message for one particular airport such as LaGuardia airport in New York, and

FIG. 6 shows a web based Internet online booking registration screen where a caller can pre-register caller booking particulars in the system.

In the description that follows, the example is for use at an airport terminal, and for descriptive purposes, the airport is shown as LaGuardia airport in New York. The invention should not be limited to only use at airports.

### DETAILED DESCRIPTION OF PREFERRED EMBODIMENTS

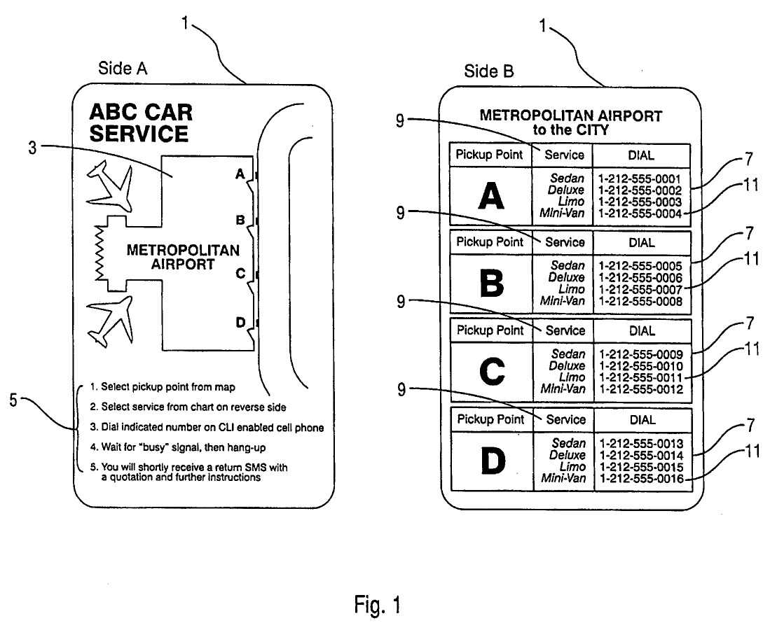

FIG. 1 shows a card 1 that is provided to callers who are potential participants in the booking service. These callers may be any person and the card 1 is merely a convenient way of providing information to the caller as to information such as pickup points and particular services that can be offered through the chauffeured vehicle booking services. Instead of utilising a card 1 a sign may be displayed at various locations throughout the airport and contain the same information as shown on Side A and Side B of the card 1. Side A of the card 1 shows a general map of the airport terminal 3, and four pickup points A, B, C, D. Instructions 5 are provided so that a caller can be guided in the correct process steps for making a chauffeured vehicle booking through the vehicle service. The steps are as follows:
1. Select a pickup point from the map 3;
2. Select service from chart on reverse side.

On the reverse side of the card there are tables 7 showing particular pickup points A, B, C and D, and the type of service vehicle 9 that may be required. Adjacent each service vehicle 9 there is provided a specific telephone number 11. Thus, each of the telephone numbers 11 has a respective pre-established unique booking purpose for each of the Call lines. These are represented by the telephone numbers 11. It can therefore be seen that for pickup point A, if a caller requires a “deluxe” vehicle, the caller must dial a particular telephone number 11 thereby making a Call on a particular Call line to a booking service. The instruction steps 5 shown on Side A of the card 1 further instruct the caller:
3. Dial an indicated number on a CLI enabled cell phone,
4. Wait for “busy” signal, then hang-up,
5. You will shortly receive a return SMS with a quotation and further instructions.

It can therefore be seen from FIG. 1 that the caller can make a mobile telephone Call to any one of a plurality of incoming Call lines at a booking service, and that each of the respective Call lines has a respective pre-established unique booking purpose.

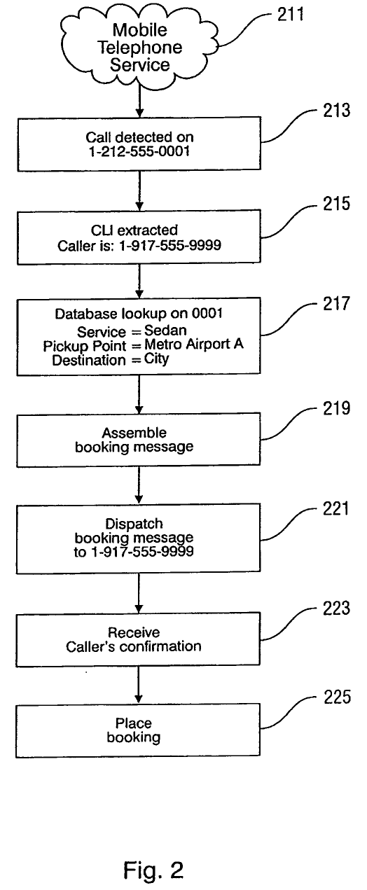

Referring now to FIG. 2 there is shown a functional flow diagram of various process steps involved in booking a chauffeured vehicle through the booking service. Here, there is provided a conventional digital mobile telephone system 211 that has a caller line identifier (CLI) facility in the service provider's system 211. A caller chooses a particular pickup point, service vehicle type, and dials the particular allocated phone number of the call line for that combination. The Call is then received at step 213. The booking service has a computerised Call answering system usable for booking a chauffeured vehicle. Typically, the computer used is a conventional PC computer suitably programmed with software that is stored on a storage medium and some additional telephony hardware that detects a CLI in an incoming call. The answering system then extracts the CLI from the booking call using a CLI detector at step 215. When the computer is configured with the software, the purpose of the Call is derived at step 217. It should be appreciated that in the case of the system being used at an airport, the chauffeured vehicles will be primarily engaged in travel between the airport and the central business district (CBD) of the local city. At step 219, a booking message is assembled based on the determined pre-established purpose for that Call line. The assembled booking message is despatched to the extracted CLI phone numbers determined at step 217. In other words, the caller's mobile telephone receives an incoming message which is a short message service (SMS) enabled message. The message invites the caller to confirm the booking. Confirmation by the caller is made at step 223. When the confirmation is received at step 223, a booking is placed for a chauffeured vehicle. The booking may be placed by providing an instruction to an operator person who can manually make the booking, or in another example, an output signal may be output from the computerised Call answering system 211 to provide a booking signal to a computerised booking despatched system of known configuration. Such computerised booking vehicle despatch systems are known in relation to for-hire transport vehicle organisations. For this reason a description of such despatch systems has not been detailed.

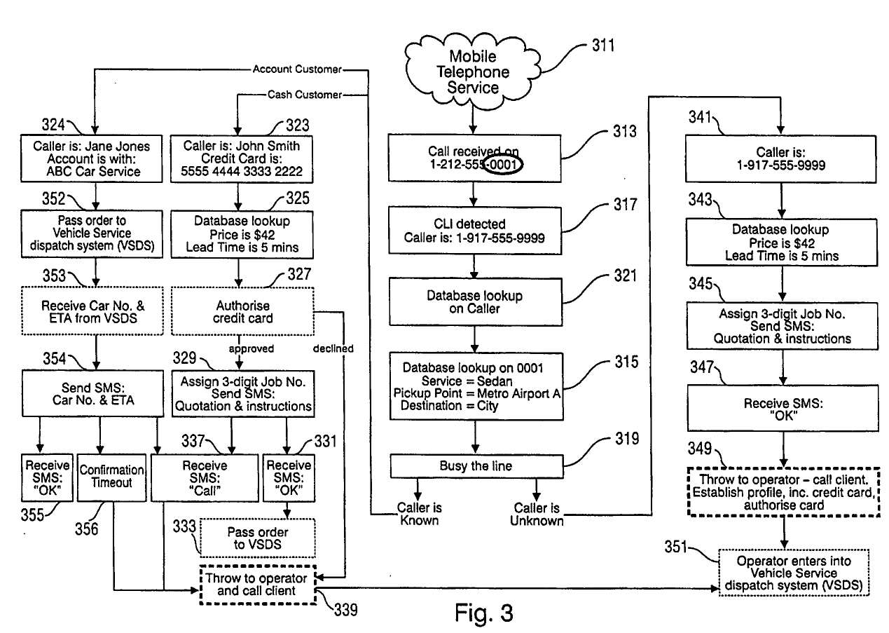

FIG. 3 is a functional flow diagram, similar to that shown in FIG. 2, but showing a detailed level. Here, a conventional digital telephone service 311 is provided. The service has a CLI facility. A user makes a mobile telephone Call to particular telephone number for the required pre-established unique booking purpose at step 313. The CLI of the incoming Call is extracted at step 317. The Call is then acknowledged as being for the pre-established booking purpose at step 315. At step 319 the computerised Call answering system will have obtained all the necessary caller information from the caller at that point of time. Thus, the line can be “hung-up”, whether answered or not. Once the CLI has been extracted, a database forming part of the computerised Call answering system 311 can be accessed at step 321 to look-up particulars of the caller.

Step 321 has two output paths.

The left hand path is where the CLI of the caller is in a database. Here, at step 323, the caller is identified as a client who settles payment at the conclusion of each journey and the particular predetermined destination such as the city central business district (CBD) can be determined from the database based on the Call line in which the caller has made the booking Call. Thus, a price can be established for the travel and a lead time determined based on the usage of the vehicles in the fleet. This is performed at step 325. Accordingly, steps 323 and 325 are steps that assemble a booking message to be forwarded to the caller using the callers extracted CLI. The credit card of the caller is also checked at step 327 to determine if a purchase on the card can be approved. If it is approved a 3 digit job number is assigned at step 329, and an SMS message is forwarded to the caller providing various particulars (as will be described hereinafter), and requesting confirmation of the booking from the caller. At step 331 the caller receives the SMS message and confirms the booking. The confirming of the booking may be effected by pressing a reply button 401 on the caller's mobile telephone and sending a confirmation code. Once the booking is confirmed by the caller, then the booking is placed to a chauffeured vehicle at step 333. The placing of this booking may be via the intermediary of an operator who physically enters a booking in a booking system. Alternatively, an output signal may be provided to a computerised booking vehicle despatch system.

If the authorisation of the credit card at step 327 is declined then this causes the system to pass the data to an operator who can Call the caller using the previously extracted CLI and enter alternative credit card particulars which can be manually approved. If approved, then an output can be provided to the vehicle despatch system. This output may be manual, or may be a signal output that automatically provides for a booking in the computerised booking vehicle despatch system.

An alternative left hand path from step 321 is where the CLI of the caller is in a database and the caller has an account established with a vehicle service. In step 352 the order is passed to the vehicle service's dispatch system for action. In step 353 the vehicle service's dispatch system provides a car number and estimated time of arrival (ETA). In step 354 an SMS message is forwarded to the caller providing various particulars.

Step 354 has three possible outcomes. At step 355, the caller confirms that the particulars are acceptable by replying “OK” by SMS. At step 356 the caller fails to respond to the particulars within a pre-determined timeout threshold. At step 337 the caller replies “call” by SMS. In the event of steps 356 or 337, details of the order are passed to a telephone operator, who makes a voice call to the caller to clarify the order.

The right hand path from step 321 is where the caller is not in the database or there is no credit card on file. The database is checked at step 343 and a message is compiled indicating the hire charge and the lead time. At step 345 a job number, being a 3 digit job number, is assigned to the possible order, and an SMS message is despatched providing the quotation and instructions for the caller. The instructions may instruct the caller to despatch an SMS message reading “ok”. At step 347 the system receives an SMS message from the caller reading “ok”. In this case, the system transfers the information to an operator so the operator can Call the caller and take credit card particulars and also authorise the credit card for the particular booking. The operator can also establish a caller profile if the caller so desires. This occurs at step 349. Once the particulars have been established and the credit card authorised then an output can be provided at step 351 to a vehicle despatch system.

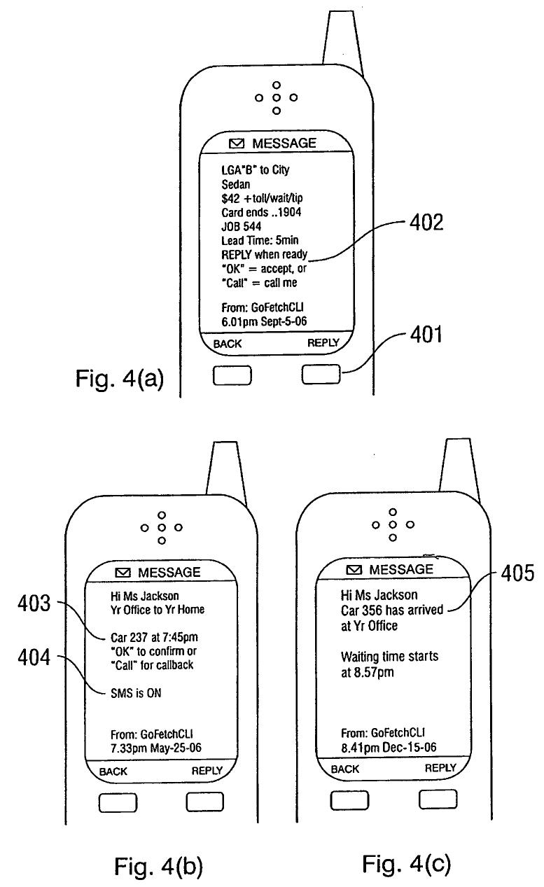

FIGS. 4a-4c show three typical messages which are received and displayed on the screen on the caller's mobile telephone following the assembling of the message and the transmission of that message to the caller's extracted CLI number. In example 402, the message display at line one shows a particular pickup point and the destination. In this case the message is abbreviated to LGA “B” to city. This indicates LaGuardia airport, at pickup point B, and delivery to city. At line two the message indicates the type of vehicle that has been ordered. At line three the cost of the journey plus any “add ons” are displayed. The “add ons” are an important legal disclaimer which this system clearly establishes in writing. The fourth line indicates the last four digits of the caller's credit card number. The fifth line indicates the job number for the chauffeured vehicle. The sixth line indicates the lead time required for the chauffeured vehicle to arrive at the particular pickup point B. The seventh line instructs the caller to reply when ready with a message indicating “Ok” for acceptance of the booking, or “Call” which requires a Call back from an operator.

In FIG. 4(b) it indicates at 403 that the caller has an account arrangement with the vehicle service which pre-establishes cost details and other requirements that have been stored against the caller at step 315. The message displays the result of placing the order with the vehicle service and instructs the caller to reply with a message indicating “Ok” for acceptance of the booking, or “Call” which requires a Call back from an operator. In this example it also indicates at 404 that an optional flag has been set against the call purpose in step 315, instructing to be informed by SMS of further progress on the order.

In FIG. 4(c) it indicates at 405 a progress report resulting from the flag, if found at step 315 as acknowledged at 404.

Other messages can be displayed in the message to take advantage of the maximum permitted characters in an SMS message.

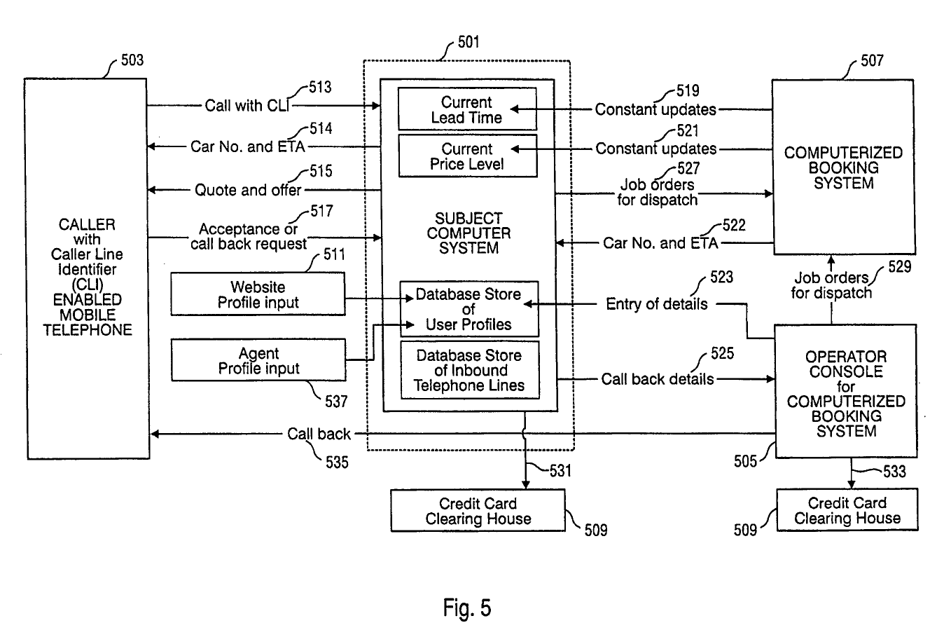

Referring now to FIG. 5 there is shown a block schematic diagram of the system. Here, a computer such as a personal computer PC 501 is configured with software held on a storage medium to operate according to the functional steps outlined in FIGS. 2 and 3. The caller's mobile telephone is shown by numeral 503. An operator console for computerised booking in the system is shown as 505. A conventional computerised booking system is shown as 507. A credit card clearing house 509 is shown connected in the system. An online Internet website is shown as 511. FIG. 5 shows that a caller places a Call to the booking service and the Call is processed by the PC 501. This is shown by the flow line 513. A booking message is assembled by the PC 501 and this message is despatched to the caller's mobile telephone 503 using the extracted CLI at flow line 515. On other occasions an actual car number and estimated time of arrival (ETA) can be passed at flow line 514. When the caller calls back to accept the offer, the order is processed by the booking service PC 501. The Call back is shown at flow line 517. The vehicle booking service PC 501 receives constant updates from the conventional computerised booking system 507 via update lines 519 and 521. These updates indicate the current lead time and the current price levels for travel to the particular destinations from the relevant pickup points. These lead times and price levels may change throughout the day depending on the loads experienced by the fleet of chauffeured vehicles. Under some circumstances, line 522 shows that an actual car number and estimated time of arrival (ETA) can be received from the computerised booking system 507. FIG. 5 also shows the possibility of operator input through the operator console 505 to store user profiles and Call back details. These are shown respectively by flow lines 523 and 525. The credit card clearing house 509 is consulted either directly via the booking service PC 501 or via the operator console 505. Job orders approved through the booking service PC 501 are relayed to the computer booking system 507 along flow line 527. Job orders are input into the computerised booking system 507 from the operator console 505 along flow line 529. The caller's credit card particulars are checked with a credit card clearing house 509 to see if the anticipated charges can be billed to the credit card. This occurs along flow line 531. The booking service PC 501 processes the confirmation of the booking. In the case where the operator confirms the booking with the caller, a similar check is made with the credit card clearance house 509 along flow line 533.

The online Internet website 511 may be accessible directly from the caller's mobile telephone 503, or may be accessible via a normal computer terminal having Internet connection. Either way, a caller can register with the system. In the case where the operator intervenes in a booking Call, the operator can, via the console 505 make a Call back to the caller using the CLI number extracted. This is shown along line 535.

FIG. 5 shows an Agent profile input along line 537. Here, an Agent may be a concierge or doorman at a particular hotel or other similar person who introduces a person to the booking service. In this case, the concierge or doorman or similar person can provide a potential user of the booking service with a card providing the website contact particulars for registering. The card may contain a code number identifying the concierge or doorman or like person. In this way, when the person registers in the booking service, they will be required to enter an Agent identification which is then stored in a store and accessible via the booking service PC 501 during the processing of a booking. In this case, when a caller makes a booking the Agent ID can be extracted and the Agent can receive a commission for any bookings that are made by that caller. This process of providing an Agent identification in the system has the effect of quickly establishing a large sized number of registrants in a new system as it provides an incentive for the concierge, doorman or like person to attract potential customers to the booking service.

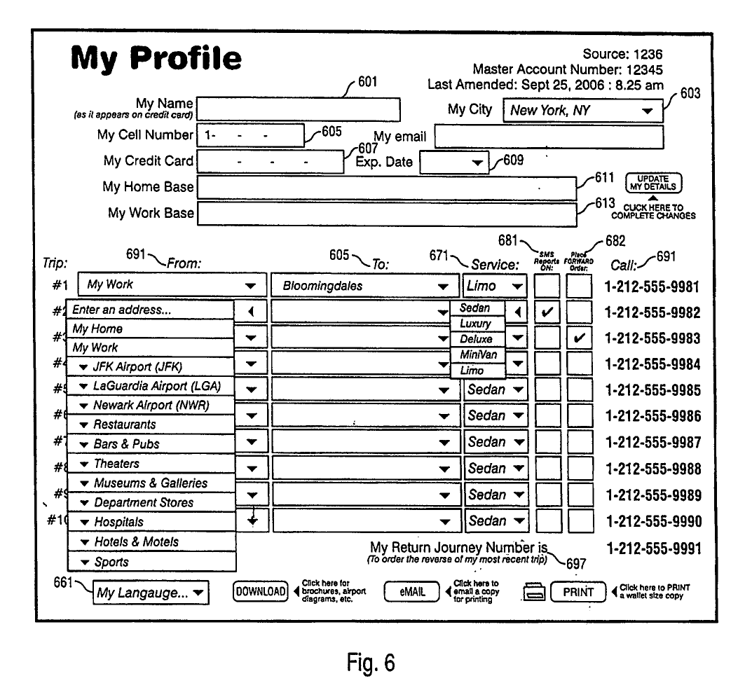

Referring now to FIG. 6 there is shown one example of an Internet website registration page. In such a scenario, a caller may have an established account with a vehicle service directly or through an employer, indicated at line 604. Alternatively, the caller may register by entering in the caller's name at line 601. The name should desirably be entered the same as the name appearing on the caller's credit card. At line 603 the caller can enter their home city. At line 605 the caller can enter their particular mobile cell number. This is the primary index for the profile. When detected by CLI, this number will call up this profile from the store. At line 607 the caller can enter their credit card number, and at line 609 the expiry date. At line 611 the caller can enter their home address or home base. At 613 the caller can enter their work address or base.

Under the “From” heading 691, the user can define their own pickup point as a manually entered address by clicking on “Enter an address . . . ”, or select “My Home” or “My Work” from the menu, which will refer to “My Home Base” 611 and “My Work Base” 613 respectively. Where an arrowhead is present, a further click on it will bring up another drop-down sub-menu of further choices. The first level menu is shown in the diagram. The “LaGuardia (LGA)” option arrowhead will in turn, bring up a sub-menu listing all the pickup points at LaGuardia. Similarly, the “Restaurants” arrowhead will bring up a list of restaurants to choose from. In this way, menus can be “nested” several layers deep. E.g. Places of Worship ->Denomination ->Individual Churches.

The destination, or “To” 605 entry functionality operates similarly to the “From” entry.

Under the service heading 671 there are a number of drop down choices for each trip definition for the profile, including the type of chauffeured vehicle “service” required. Under the heading “Call” 691, there are listed a number of Call lines which represent Call line telephone numbers for bookings that can be given user defined purposes, specific to this individual profile. It can be seen that at Trip 1, this user has selected a limo vehicle to go from “My Work” to “Bloomingdales”. The Call line number is shown as 1-212-555-9981. This then represents a pre-established unique booking purpose if a Call is made to that Call line from this CLI. At 697, there is shown a return journey Call line number. This number is for a Call which is for a return journey based on the last booking made with the same CLI. Thus, a caller can book a particular Call to a particular destination and then once any business is finished at that destination, the caller can dial the return journey Call line number and the system will determine the last booking made with the same CLI, and will enable a return journey to be booked without the caller having to re-enter particulars of the return journey.

Two other settings which can be nominated against each trip definition are at 681, where the caller can indicate a requirement for progress reports in the processing of the order and 682, where the caller can activate a forward order process which will request a pick up time rather than placing an immediate order.

Another profile setting available to the caller is the ability to set a Language 661. In this function, both the on screen language and the SMS responses when accessing the system will reflect the selection. In this way a non-English speaker is automatically translated and need not correspond in an unfamiliar language.

In the system outlined above, the CLI of the caller can be relayed to the chauffeured vehicle at the time of making a booking. In that way, if the caller is not present at the pickup point when the chauffeured vehicle arrives, the chauffeur can call the caller who made the booking using the CLI. In that way, there can be clarification as to whether the caller is at the particular pickup point or some other nearby pickup point. Appropriate corrective procedures can then be implemented between the chauffeur and the caller.

It should be appreciated that the above system enables for protection against the problem of “intra-company job poaching”. It is not uncommon that a person who makes a booking for a chauffeured vehicle may flag any vehicle that he recognises as being from the same car service company. In this scenario, under existing practices, if the chauffer of a chauffeured vehicle other than that which was dispatched for this job number effects the pickup then the chauffeur of the originally booked vehicle will subsequently experience a “no-show” at the pickup point. Under the subject system, in such instance, the correct chauffeur can call the person who made the booking using the CLI number and as the delinquent driver's ID and the vehicle's ID must be clearly displayed in the vehicle, the correct chauffeur can ask for the identify of the poaching chauffer, and then report the incident to the vehicle booking service. Under existing practises, a poached job can rarely be tracked by the vehicle booking service, and therefore the vehicle booking service cannot claim its rightful commission for such trips. The vehicle booking service will therefore apply severe sanctions against such a delinquent chauffer if apprehended. Under the subject system, the practise will therefore be greatly discouraged, due to the high likelihood of apprehension.

The following description outlines several likely scenarios using the vehicle booking service

### At an Airport:

### Basic Airport Scenario—Established User

6.00 pm John Smith disembarks his aircraft at LaGuardia, turning on his cell phone.

6.01 pm He uses his speed-dial feature to dial a selected call line. The number rings twice, and then goes “busy”. It has not answered, so he will not be billed for the call. He hangs up.

6.01:30 pm He receives an SMS message on his phone which reads:
LGA “B” to City
Sedan
$42+toll/wait/tip
Card ends . . . 1904
JOB 544
Lead Time: 5 min
REPLY when ready
“OK”=accept
“Call”=call back
(Note: This is 125 characters of 140 allowable)

6.22 pm He collects his luggage from the carousel, and before heading out to the Ground Transportation area, at the received SMS screen on his phone, he selects “Reply”, types in “OK” and sends.

6.28 pm He reaches the kerb side point described on his credit card sized, LaGuardia Reference Map as “Pickup Point B” to find his driver waiting with “Job No. 544” clearly displayed in the side window.

7.25 pm At his destination he signs a docket acknowledging the charges on Job No. 544, and says goodbye to his driver. No imprint of his credit card is required.

### Variation #1—First Time User

7.30 pm Jane Jones reads about the service in “Continental Airlines Inflight Magazine” coming in from Chicago. The advertisement has several tear-off cards, one of which she removes for reference.

8.00 am She disembarks . . .

8.01 am She dials a selected Call line indicated on the Card . . .

8.01:30 am She receives an SMS message on her phone which reads:
JFK “C” to City
Sedan
$42+toll/wait/tip
Casual
JOB 486
REPLY when ready
“OK”=accept
Will contact for credit card
(Note: This is 114 characters of 140 allowable)

8.22 am She collects her luggage from the carousel, and before heading out to the Ground Transportation area, at the received SMS screen on her phone, she selects “Reply”, types in “OK” and sends

8.22:30 am Her cell rings and she gets a call from an operator, who requests her credit card details. Upon completion, she is asked if she would like to leave the details on file so that next time, this call will be unnecessary. Because she is a regular to NY, she agrees. The operator suggests that she ask her driver for a brochure explaining how to establish a full personal profile via the Internet.

8.28 am She reaches the kerb side . . .

8.35 In transit, she receives the suggested brochure.

9.25 am At her destination she signs a docket . . .

8.30 pm In her hotel room, she logs onto the website as outlined in the brochure. Once she has established a full profile, she settles down to plan her full week's travel requirements.

### Variation #2—The Well Prepared Traveller . . . And How to Market to Him.

### While Preparing for His Trip to NY . . .

Bill Blacksmith is prompted by his travel agent to think about the advantages of the legendary NY car services. The agent offers to set up a profile for him, and gives him a brochure describing the service. The agent takes the first step, by creating a username and password. The brochure tells Bill how to do the rest, from the comfort of his own PC.

That evening, he logs on himself, using his PIN, and takes the time to enter some further details into his profile. They include his cell phone number and some minimum credit card details.

With a few easy clicks, he also defines up to 10 anticipated journeys. Some may be regular trips to be repeated, some may just be hopeful intentions. For example:

1) From his hotel to his company's local office,

2) Office to hotel,

3) Office to client,

4) Hotel to Times Square Ticket Office,

5) Times Square Ticket Office to Hotel, etc . . .

Upon completion he receives an email with a complete description promoting the service and a printout of his 10 defined journeys with their Trigger numbers.

### On the Day of his Arrival . . .

As a known user with an established profile, at the airport he does not need to speak to an operator to order his transport to the city. Even as a first-time user, his whole experience serves to reinforce his commitment to the service.

### For the Duration . . .

A simple Trigger call will place an order according to his profile at any time. One Trigger call gets him to the Office. Another takes him to Broadway. A simple logon to the website from his hotel room, and he can change the profile at any time during his stay. Each evening, he can plan his next day.

### The “Backtrack” Feature . . .

Bill will also discover that he has a very simple way to retrace his steps, having taken a trip. The system automatically remembers his last booking used. If for example this was to the ferry terminal for the Statue of Liberty. As the ferry heads back, he dials his “Backtrack” number. He is immediately offered the return journey to his hotel. A simple calculation based on the advised lead time, and he replies “OK” at just the right time to avoid waiting . . . and waiting time charges.

### “Poach-Proofing” . . . or Built-in Error Recovery . . .

If ever Bill misjudges the lead time, or accidentally waits on the wrong corner, or gets into the wrong vehicle, his driver can quickly clarify the situation, because his dispatch instructions from the company will always include his client's cell number. No-show? Just call the client!

### The Job Number is the Mating Game . . .

The Job Number is a key facilitator of the meet-up at a busy pick-up point. The client is aware from his SMS offer, what the number is. It also remains stored on his cell phone for further reference. The driver should take full advantage of this by clearly displaying it in the side window of the vehicle, as he approaches the pick-up.

Each vehicle will be equipped with a simple ring-bound book with split pages which can be manipulated easily to display the three-digit number in a standard format that the customer can easily locate and identify.

Credit Card Payment . . . The best Method All-Round.

Because the transaction is tied together with date, time and job number, it should never be necessary to take an imprint in the car. A simple signed docket will make it impossible for a card-holder to contend that the journey was not consumed. This method of settlement means maximum convenience for both driver and passenger, and maximum protection for both booking service and driver.

### The Call Back Operator . . .

While at first glance the call-back (for card details) imposes a considerable extra overhead on the system, it most certainly should not be viewed this way. There is far less data to be collected from the client than would be true if the caller had called-in in the conventional way. Much more importantly, it also provides an excellent way to fully engage the client for future work. It is a superb opportunity to market all the add-on benefits outlined, and these agents* should be fully trained to maximize this benefit. *As a major incentive to have this facet handled professionally, call-back operators should be classified as agents (see “The AGENT as a Marketing Tool . . . ”, below)

### Marketing

1. The in-flight magazines, already extensively used in a broad, relatively unfocussed way, can now zero right in. By including tear-off, credit card sized, “walletable” cards in each magazine, passengers will be able to grab a reference card for each NY airport, ready to try out straight away.

2. Wall advertisements in any airport, bus or train terminal can be used with pinpoint accuracy to catch the traveller's eye—leading to an impulse test try.

3. As with any Internet offering, the site must be well designed for trapping interest from all the best search engines. Consideration should also be given to sponsored links.

### The AGENT as a Marketing Tool

A primary source of custom will be the hospitality industry. The concierge, the doorman, the call-back operator or the travel agent an incentive to cause would-be users to sign-up. On each person's personal profile is an unalterable notation of “Source”. Where people join themselves up, this will read “Website”, but if an agent signs them up, the agent's ID will be registered against that client . . . Forever.

Each order placed by that person, on this trip or potentially many others—maybe five years hence, will result in a 1% commission being credited to the agent's account. This will act as a serious incentive for agents to sign as many users as possible. A concierge who can sign a large volume of “happy travelers” stands to set up a sizeable, long-term personal cash cow. For the travel agent who may at times promote the product to whole conventions of clients, this will be a bonanza. When recruiting call-back operators, this feature should command first class people for the task.

With no other entity to compensate for any further orders from this user, we can afford to simply credit each “micro-commission” to the original agent's name, to be held in a master trust account. “Tick” . . . , every time they place an order—forever.

Agents will be able to log onto their account via the website at any time, and leave instructions when desired, to remit the balance to a bank account or credit card of their choice.

### Internet NOT Required! . . .

Provided a user's profile establishes a “Home” base, a set of “default” destinations will be attached. For example, any given hotel will have a standard set of common destinations, including the three airports, based specifically around it. To change a home base, users simply SMS “Call” in response to their next quote and an agent will call and amend their profile.

If the user does not wish to access the Internet to vary their default destinations, they have the option of changing their current “set” to any of many different themed sets by sending a simple SMS code to the host. A booklet can outline many sets—for theatres, designer shops, computer nerds, camera shops, shopping malls, tourist attractions, etc. These highly suggestive sets will prompt many car trips which would previously have gone to taxis without a second thought from the patron.

### For New Yorkers AROUND TOWN:

Obviously, significant pickup points such as hotels, railway stations, bus deports, tourist spots, etc. can be handled the same ways as an airport.

For established users, the next best solution is a recorded profile. Each user's profile allows them to enter a job definition for up to 10 target telephone numbers. The booking call would “pull up” whichever job was held against the call line number called. The profile can define both pickup point (e.g. My Home) and destination (e.g. My Office) as well as service required (e.g. Sedan). This feature is administered via the website using PIN access. A hub, such as the caller's home or office can be nominated which will operate in the same way as the home hotel does for a tourist.

For a sophisticated user, the CLI from an SMS can be extracted to gain a very versatile tool. A simple protocol will allow sophisticated users to define their own pickup points by texting as followings:

Using “&”
aa&ss where aa=the number of the Avenue ss=the number of the Street. Or
B&ss where B=Broadway and ss=the number of the Street.

Using “/”
nnn. . /ss where nnn. .=address number and ss=the number of the Street.

Using “-”
nnn. . -aa where nnn. .=address number and aa=the number of the Avenue.

Target telephone numbers can be raised for all significant destinations: LGA, JFK, NWR, Grand Central Station, Times Square Ticket Office, etc.

As an example: Texting “B&47” (four characters) to the right target number, orders a Sedan, pickup Broadway and 47^{th}, destination LaGuardia.

### User Benefits

Benefits can be summarized as follows:
1. No need to talk to an operator. Once a user profile is established, there is no need to talk to an operator—ever again. By means of the language selector in the profile screen, non-English speakers can negotiate an order without any of the mis-communications so common when people get outside of their primary language.
2. Absolutely intuitive. No complicated processes—enquire, quote, accept. Three simple steps. And yet if there is a complication—“call me to discuss it”.
3. Completely unambiguous. All the details of the order, right down to the order number to be displayed by the driver, are stored automatically in the cell phone.
4. Test for a car at no cost. By not answering the first call, the caller has literally nothing to lose by checking availability. As the car service does not commit a car until the order is confirmed with an “OK”, this imposes no burden on the fleet also.
5. Minimized waiting. By careful use of the “Lead Time” to calculate exactly when to be at the pick-up point, tedious kerb-side waiting and expensive waiting time can be cut to a minimum.
   Orders will be made from the hotel room, or the lunch table, or the like.
6. Fail-safe. If the driver can't find the caller, he will call to clarify the meet-up.
7. Made to order for the forward planner. For those who like to get ahead of the game, just a few minutes on the ‘net and one can plan your whole day/week/holiday or business trip!
8. Made to order for the last minute planner. Suddenly confronted by a long queue at the taxi rank at LaGuardia? It's now easy to check for a car!

Modifications may be made to the invention as would be apparent to persons skilled in the chauffeured booking arts. These and other modifications may be made without departing from the invention the nature of which is to be determined from the forgoing description and the offended clients.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in any country.

1. A chauffeured vehicle booking service whereby a person can order a chauffeured vehicle using a conventional digital mobile telephone having a caller line identifier (CLI) facility in the callers service providers system
said booking service having a computerised call answering system that can answer a booking call made by a mobile telephone to any one of a plurality of incoming call lines each having a respective pre-established unique booking purpose,
Said answering system having a CLI detector for extracting the CLI from the booking call,
Said answering system being configured to associate the extracted CLI with the incoming call line, and to assemble a booking message based on the pre-established unique booking purpose for that call line and, to dispatch that message to the callers mobile telephone using the extracted CLI, and to invite confirmation, and
following confirmation by the caller, placing the booking with a chauffeured vehicle.

2. A booking service as claimed in claim 1 wherein the mobile telephone is a Short Message Service (SMS) enabled mobile telephone and wherein the assembled booking message is an SMS message to be sent as an SMS message.

3. A booking service as claimed in claim 1, comprising having the answering system provide a booking initiation signal to a computerized booking vehicle dispatch system to place the booking.

4. A booking service as claimed in claim 1, wherein the pre-established unique booking purpose identifies at least one of, but not limited only to:
1. Caller's pick-up location
2. Caller's destination
3. Caller's choice of vehicle
4. Cost of travel in the vehicle
5. Time to wait before vehicle will arrive to collect caller
6. Caller's name
7. Job number

5. A booking service as claimed in claim 1 wherein the confirmation by the caller is achieved by the caller using the mobile telephone and calling the same call line that the dispatched message from the answering system was dispatched from.

6. A booking service as claimed in claim 5, wherein the confirmation by the caller is by using the CLI detector to detect the CLI in the confirmation call and using a CLI matcher to match that CLI with the callers CLI used when dispatching the assembled booking message.

7. A booking service as claimed in claim 1 wherein the caller has pre-registered with the booking service and provided caller credit card particulars in the registration, a store associated with the answering system storing the registration particulars and wherein the answering system is configured to access the store to extract the callers credit card particulars, and to automatically authorise the charge on the credit card for the booking service, and/or the booked travel costs.

8. A booking service as claimed in claim 7 wherein the caller has not pre-registered with the booking service, and wherein the assembled booking message includes a message that indicates that the caller will be contacted by an operator for credit card particulars, and wherein an operator is then provided with a message to contact the caller using the extracted CLI and obtain a confirmation of the booking and credit card particulars, and wherein authorisation is then raised against the credit card for the booking service and/or the booked travel costs.

9. A booking service as claimed in claim 8 wherein when the credit card particulars are taken, the caller is asked by an operator if the credit card particulars are required be stored for future use in the system, and if the answer is ‘yes’ then storing the credit card particulars in the store for future use.

10. A booking service as claimed in claim 1 including an online Internet website for the permitting of a callers registration and credit card particulars, and wherein the web site is interfaced to the answering system to provide the callers registration and credit card particulars to the store for subsequent retrieval by the answering system for use during a booking.

11. A booking service as claimed in claim 10 including an Agent Identification Process in the web site, whereby a person who introduces the caller to the web site can be identified as an Agent in the callers registration and stored with the caller registration so that when a caller makes bookings from the mobile phone the Agent can be identified and awarded commissions for the bookings.

12. A booking service as claimed in claim 1, and having a call line dedicated for a return journey purpose, whereby if a call is made to that call line, the CLI will be extracted from that call and matched with the last booking made with the same CLI and a return journey booked.

13. A method of booking a chauffeured vehicle said method comprising,
using a conventional digital mobile telephone having a caller line identifier (CLI) facility in the callers service provider's system to make a booking call to a call line that has a pre-established unique booking purpose,
extracting the CLI from the call,
assembling a booking message based on the pre-established unique booking purpose,
forward the booking message to the caller's mobile telephone using the extracted CLI,
inviting the caller to confirm the booking, and
following confirmation by the caller, providing a booking output that can be used to make a chauffeured vehicle booking for the caller.

14. A method as claimed in claim 13 comprising assembling the booking message as an SMS message, and
dispatching the SMS message to the callers telephone.

15. A method as claimed in claim 13, comprising providing the booking output as a booking initiation signal to a computerized booking vehicle dispatch system.

16. A method as claimed in claim 13, comprising assigning the pre-assigned booking purpose as at least one of, but not limited only to:
1. Caller pick up location
2. Caller's destination
3. Caller's choice of vehicle
4. Cost of travel in the vehicle
5. Time to wait before vehicle will arrive to collect caller
6. Caller's name
7. Job number

17. A method as claimed in claim 13, comprising providing a confirmation of the booking by the caller using the mobile telephone and calling the same calling line that the dispatched booking message was dispatched from.

18. A method as claimed in claim 17, comprising confirming the booking by the caller, by extracting the CLI from the confirmation call and matching the extracted CLI with the extracted CLI obtained at the time the booking was requested by the caller.

19. A method as claimed in claim 13, comprising
pre-registering the caller and the caller's credit card particulars and storing those particulars in a store, and
extracting those particulars from the store,
and automatically authorising a credit card charge for the booking service, and/or the booked travel costs.

20. A method as claimed in claim 19, comprising establishing that the caller is not pre-registered, and providing the assembled booking message with a message that the caller will be contacted by an operator,
having the operator contact the caller using the extracted CLI, and
obtaining confirmation of the booking, and having the operator obtain the caller credit card particulars, and then authorising a credit card charge for the booking service, and/or booked travel costs.

21. A method as claimed in claim 20, comprising having the operator ask the caller if the credit card particulars are required to be stored for future booking use, and if the answer is ‘yes’, storing the credit card particulars in said store.

22. A method as claimed in claim 19, comprising using an on-line Internet web site for permitting of callers registration and credit card particulars, and interfacing the web site to said store so those particulars can be stored and used in bookings.

23. A method as claimed in claim 22, comprising
providing an Agent identifier in the web site whereby a person who introduces the caller to the web site can be identified,
storing the Agent identifier in said store,
and upon the caller making a booking determining the Agents identifier and awarding commissions to the Agent for bookings made from the callers mobile telephone.

24. A method as claimed in claim 13, comprising processing a call made by a caller on a call line having a dedicated purpose for a return journey to extract the CLI from that call and to match that CLI with the last booking made with the same CLI and to make a return journey booking for the caller.

25. A data storage medium containing Software for configuring a computer to function as a computerized call answering system usable for booking a chauffeured vehicle when a caller uses a conventional digital mobile telephone having a caller line identifier (CLI) facility in the callers service providers system, said software comprising:
a function to enable one of a plurality of unique booking purposes to be assigned to respective call lines,
a function to receive a call made to any one of the call lines by a caller,
a function to extract the CLI from a received call,
a function to assemble a booking message based on the assigned purpose for the particular call line, said message including an invitation to confirm booking,
a function to forward the booking message to the callers mobile telephone using the extracted CLI,
a function to receive the callers confirmation, and
a function to provide a booking output that can be used to make a chauffeured vehicle booking for the caller.

26. A data storage medium as claimed in claim 25 wherein the software assembles the booking message as a Short Message Service (SMS) for forwarding as an SMS message to the callers telephone.

27. A data storage medium as claimed in claim 25, said software comprising providing the booking output as a booking initiation signal so that signal can be supplied to a computerised booking vehicle dispatch system.

28. A data storage medium as claimed in claim 25, said software comprising a function to only process a confirmation if the booking by a confirmation call is made to the same call line that the booking message is forwarded from.

29. A data storage medium as claimed in claim 28, said software comprising a function for confirming the call by extracting the CLI from the confirmation call and matching the CLI with the extracted CLI obtained at the time the booking was requested by the caller.

30. A data storage medium as claimed in claim 25, said software comprising a function to permit pre-registering of a callers credit card particulars and for storing those particulars in a store, and a function to extract those particulars from said store and automatically authorise a credit card charge for the booking, and/or the booked travel costs.

31. A data storage medium as claimed in claim 30, said software comprising:
a function to determine if the caller is not pre-registered and to provide the assembled booking message with a message that the caller will be contacted by an operator,
a function for providing a request to an operator to contact the caller so that the operator can make a manual confirmation of the booking for the caller.

32. A data storage medium as claimed in claim 31, said software comprising a function to enable an operator to manually enter non registered caller particulars and credit card particulars into said store.

33. A data storage medium as claimed in claim 30, said software comprising a function to enable interfacing with an online Internet web site to permit a caller to pre-register particulars and credit card particulars and to store those particulars in said store.

34. A data storage medium as claimed in claim 33, said software comprising a function to permit an Agent identifier to be stored in said store, said Agent identifier being that of an Agent who introduces the caller to the web site, and a function to record a commission to the Agent each time the caller makes a booking.

35. A data storage medium as claimed in claim 25, said software comprising a function for processing a call made by the caller on a call line having a dedicated purpose for a return journey booking, to make that return journey booking by extracting the CLI and matching it with the last booking made with the same CLI.

36. A chauffeured vehicle booking service whereby a person can order a chauffeured vehicle using a conventional digital mobile telephone having a caller line identifier (CLI) facility in the callers service providers system
said booking service having a computerised call answering system that can answer a booking call made by a mobile telephone to any one of a plurality of incoming call lines each having a respective pre-established unique booking purpose,
Said answering system having a CLI detector for extracting the CLI from the booking call,
Said answering system being configured to associate the extracted CLI with the incoming call line, and to assemble a booking message based on the pre-established unique booking purpose for that call line and, to dispatch that message to the callers mobile telephone using the extracted CLI, and to either or both
(a) invite confirmation, and
following confirmation by the caller, placing the booking with a chauffeured vehicle, or
(b) if the caller is an account holder registered in the service, placing the booking with a chauffeured vehicle following extraction of the CLI and use of the extracted CLI to determine that the caller is registered in the service following extraction of the CLI and use of the CLI to determine that the caller is registered in the service.

37. A method of booking a chauffeured vehicle said method comprising,
using a conventional digital mobile telephone having a caller line identifier (CLI) facility in the callers service provider's system to make a booking call to a call line that has a pre-established unique booking purpose,
extracting the CLI from the call,
assembling a booking message based on the pre-established unique booking purpose,
forward the booking message to the caller's mobile telephone using the extracted CLI, and either or both
(a) inviting the caller to confirm the booking, and
following confirmation by the caller, providing a booking output that can be used to make a chauffeured vehicle booking for the caller., or
(b) if the caller is an account holder already registered in the service, placing the booking with a chauffeured vehicle following extraction of the CLI and use of the CLI to determine that the caller is registered in the service following extraction of the CLI and use of the CLI to determine that the caller is registered in the system.

38. A data storage medium containing Software for configuring a computer to function as a computerized call answering system usable for booking a chauffeured vehicle when a caller uses a conventional digital mobile telephone having a caller line identifier (CLI) facility in the callers service providers system, said software comprising:
a function to enable one of a plurality of unique booking purposes to be assigned to respective call lines,
a function to receive a call made to any one of the call lines by a caller,
a function to extract the CLI from a received call,
a function to assemble a booking message based on the assigned purpose for the particular call line,
a function to forward the booking message to the callers mobile telephone using the extracted CLI, and either or both:
(a) a function to receive a callers confirmation of the booking, and
a function to then provide a booking output that can be used to make a chauffeured vehicle booking for the caller Or
(b) a function to determine if the caller is an account holder already registered in the service, and a function that can be used to make a chauffeured vehicle booking for the caller following extraction of the CLI and use of the extracted CLI to determine that the caller is registered in the service.
